(19) United States
(12) Patent Application Publication
(10) Pub. No.: US 2025/0238976 A1
(43) Pub. Date: Jul. 24, 2025

(54) DISTRIBUTED EVIDENCE COLLECTION AND ANALYSIS FOR SCENE RECONSTRUCTION BY A NETWORK OF SENSORS

(71) Applicant: Nexar Ltd., Tel Aviv (IL)

(72) Inventor: Lev Yitzhak Lavy, Misgav Dov (IL)

(21) Appl. No.: 19/010,637

(22) Filed: Jan. 6, 2025

Related U.S. Application Data
(60) Provisional application No. 63/623,824, filed on Jan. 23, 2024.

(51) Int. Cl. G06T 11/00; G06V 20/58

(52) U.S. Cl. CPC G06T 11/003; G06V 20/58

(57) ABSTRACT

A system for scene reconstruction from data captured by a network of sensors, including a plurality of sensors capturing evidence of a scene in which an event occurred, a processor collecting the evidence captured by the sensors and adding temporal and spatial data to each evidence, in response to the event having occurred, a consent messager transmitting messages in the form of data requests and evidence to owners of said sensors, and receiving messages in the form consents from the owners, a network connecting the sensors, the processor and the consent messager, a plurality of analyzers, and an interface enabling analysis by the analyzers of evidence for which the consent messager received a consent, to reconstruct the scene when and where the event took place.

### REFERENCE TO RELATED APPLICATION

This application is a non-provisional application claiming the benefit of U.S. Provisional Application No. 63/623,824 filed on Jan. 23, 2024, the contents of which are incorporated herein by reference in their entirety.

### FIELD OF THE INVENTION

The present invention relates to use of multiple sensors to reconstruct a scene of an event, such as a collision of vehicles.

### BACKGROUND OF THE INVENTION

In many fields such as claim adjustment, collision, crime scene investigation, and other post-event scene analysis, evidence collection is the basis for accurate analysis and insights. Nowadays most of the work is done manually or using artificial intelligence (AI) systems with Internet of Things (IoT), where the systems are owned by a single entity, such as cameras deployed by a city or by a government. When an event occurs, the parties involved have no access or a very limited view from their own devices, limiting the freedom of obtaining information. Even in cases where the owners of the digital evidence have a motivation to share, they are many times unaware of the fact they have relevant data.

### SUMMARY

Embodiments of the present invention relate to a system that provides distribution of evidence, both in collection and analysis, of data gathered by various devices present at a scene or passing nearby, owned by any number of entities. The system includes the following components:
Sensors that capture evidence.
A device that collects sensory evidence and adds time and spatial signatures for later processing, if available, with accuracy of both the measurement of evidence and the signature. The device may be owned by any number of parties.
A storage device that collects sensory information for subsequent use.
A consent messaging system to distribute data requests and evidence data. The consents include auto consent, one-time consent, delayed consent, and revocable consent.
An encryption system storing each piece of evidence by source and usage reference.
A network to connect all of the above, such as a vehicle-to-vehicle (V2V) network or an entity-to-entity (E2E) network, or via shared cloud entities.
A distributed analysis system with a plurality of analysis system providers, either automatic or human experts.
A front-end system to allow examination of evidence, analysis and manual measurements while selecting data and analysis providers.

Any of the communication and analysis, such as triggering, transmission and analysis of evidence, may be implemented by either a central server, peer to peer communication, or another distributed architecture.

There is thus provided in accordance with an embodiment of the present invention a system for scene reconstruction from data captured by a network of sensors, including a plurality of sensors capturing evidence of a scene in which an event occurred, a processor collecting the evidence captured by the sensors and adding temporal and spatial data to each evidence, in response to the event having occurred, a consent messager transmitting messages in the form of data requests and evidence to owners of said sensors, and receiving messages in the form consents from the owners, a network connecting the sensors, the processor and the consent messager, a plurality of analyzers, and an interface enabling analysis by the analyzers of evidence for which the consent messager received a consent, to reconstruct the scene when and where the event took place.

There is additionally provided in accordance with an embodiment of the present invention a method for reconstructing a scene from data captured by a network of sensors, including in response to occurrence of an event, collecting evidence captured by a plurality of sensors, adding temporal and spatial data to each evidence, transmitting messages in the form of data requests and evidence to owners of the sensors, receiving messages in response to the transmitting in the form of consents from the owners, and analyzing evidence for which a consent was received to reconstruct the scene when and where the event took place.

### BRIEF DESCRIPTION OF THE DRAWINGS

The present invention will be more fully understood and appreciated from the following detailed description, taken in conjunction with the drawings in which:

FIG. 1 is a method for scene reconstruction using a plurality of sensors, in accordance with an embodiment of the present invention;

FIG. 2 is a system for scene reconstruction using a plurality of sensors, in accordance with an embodiment of the present invention; and

FIG. 3 is a use case of evidence collection, in accordance with an embodiment of the present invention.

For reference to the figures, the following index of elements and their numerals is provided. Similarly numbered elements represent elements of the same type, but they need not be identical elements.

Table of elements in the figures

| Element | Description |
|---|---|
| 10 | event |
| 100 | system for event reconstruction |
| 110 | evidence collector |
| 120 | vehicle dashcam |
| 130 | traffic camera |
| 140 | phone camera |
| 150 | vehicle ADAS system |
| 160 | data sources |
| 170 | insurance provider |
| 180 | analyzer |
| 190 | judge/adjustor |
| 1000 | method for event reconstruction |
| 1010-1050 | method operations |

### DETAILED DESCRIPTION

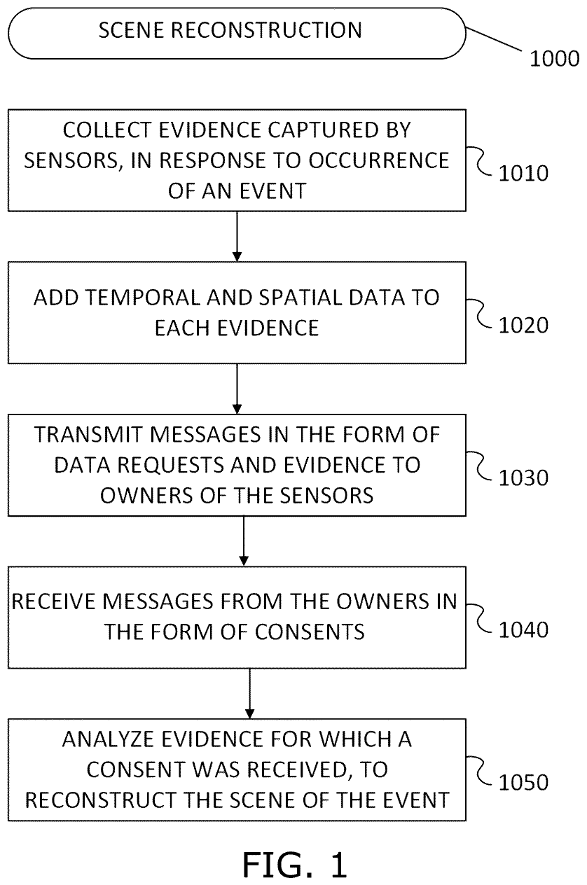

Reference is made to FIG. 1, which is a method 1000 for scene reconstruction using a plurality of sensors, in accordance with an embodiment of the present invention. At operation 1010 evidence captured by sensors is collected, in response to occurrence of an event. At operation 1020, temporal and spatial data is added to each evidence. At operation 1030, messages in the form of requests and evidence are transmitted to users of the sensors. At operation 1040 response from the owners in the form of consents are received. Finally, at operation 1050 the evidence for which a consent was received is analyzed, in order to reconstruct a scene at the time and place that the event occurred.

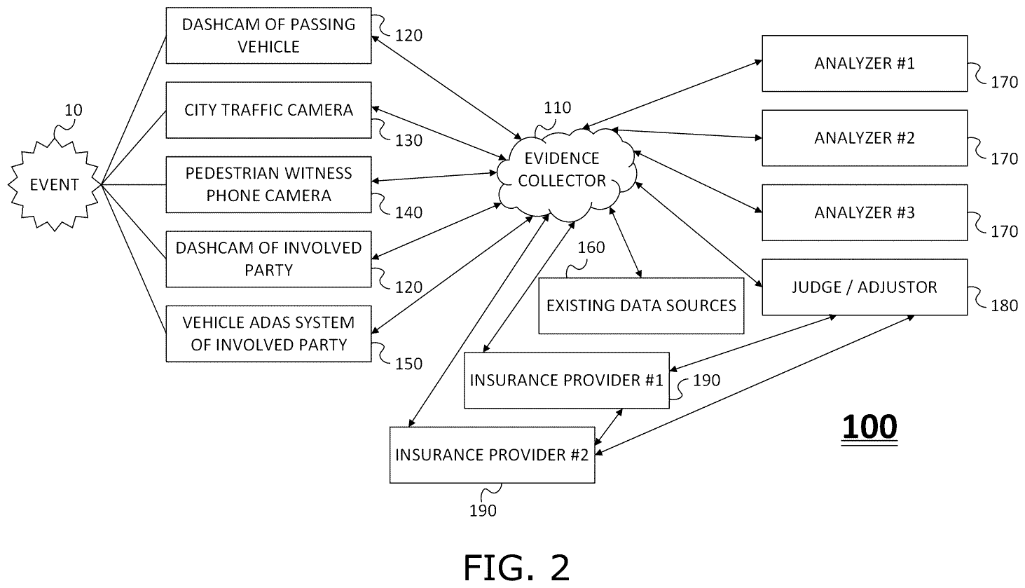

Reference is made to FIG. 2, which is a system 100 for scene reconstruction using a plurality of sensors, in accordance with an embodiment of the present invention. FIG. 2 shows reconstruction of a scene of an event 10, using an evidence collector 110. Evidence collector 110 communicates with multiple cameras, include vehicle dashcams 120, traffic cameras 130, and pedestrian phone cameras 140. Evidence collector 110 also communicates with advanced driver assistance systems (ADAS) 150 of vehicles, and with pre-existing data sources 160. Each camera, ADAS and data source provides fragments of the scene of event 10.

Evidence collector 100 transmits these scene fragments to various analyzers 170, which together reconstruct the scene of event 10. The reconstructed scene is provided to an insurance claim adjustor or, in the case where event 10 is a crime, to an investigator and a court of law 180, for evaluation. Finally, insurance adjustor 170 communicates with one or more insurance providers 190 to arrange a settlement.

### Use Case: Collision Reconstruction

For collision reconstruction, claim adjusters and collision investigators 180 obtain partial information or visit a collision scene, resulting in partial understanding of the scene timeline and impact, which may lead to incorrect conclusions.

Most common practice today is to use a dashcam 120 where only one field of view is provided. As a result, evidence and context leading to the event is missing. Furthermore, a source of evidence provided by one party that has an agenda may be prone to editing or even to deep fake with modern technology. In distinction, distributed evidence is much harder to fake.

To handle multiple sources, embodiments of the present invention use one or more cloud system evidence collectors 110 that distribute evidence requests, consent requests, and data, and that enable distribution to consumers and to analysis providers 170.

### Evidence Collector 110

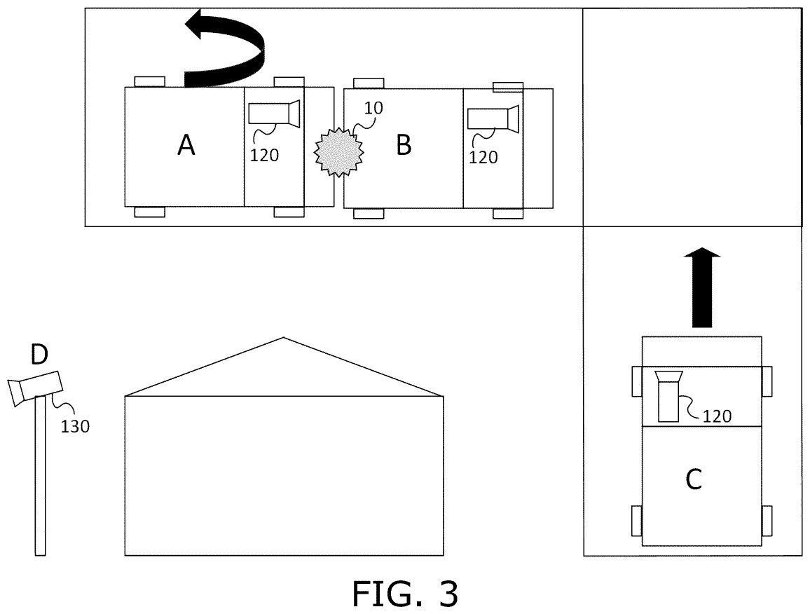

Consider the following exemplary hit-and-run scene, shown in FIG. 3.
1. Two vehicles, A and B, approach a T-junction. Vehicle B safely slows and stops to allow a vehicle C to pass.
2. Vehicle A did not maintain a safe distance behind vehicle B, and collides with the rear of vehicle B.
3. Vehicle A reverses and makes a U-turn to escape the scene.
4. There is a traffic camera D that captures vehicles A and B prior to the collision.
5. Each of vehicles A, B and C has a dashcam 110.

All parties in the scene, namely, vehicles A, B, C and camera D, have devices including a camera and a clock, providing evidence of a location, either fixed or by GPS, and of a time. Dashcams 120 also contain accelerometers to measure acceleration.

Consider the timeline:
1. At the time of collision, tc, vehicles A and B automatically detect, using their accelerometers, that a collision has occurred, generating a clip containing video before and after the collision.
2. At a time t₁, vehicles A and B send a trigger of event request automatically to evidence collector 110 using a network connection.
3. At a time t₂, evidence collector 110 analyzes the requests with an anonymized data signature of time, location and impact, detects a multiple vehicle collision, and sends an evidence request to vehicle C, which is known to be within range.

4. At a time t₃, evidence collector 110 broadcasts a request to camera D, that is located in a known position, and to vehicle C via a V2V system to trigger local collection of data. In case vehicle C is not part of the V2V system, vehicle C receives a global information request via an E2E system notification, which does not require shared location and availability in advance.

Note that at this point no private information has been shared. Evidence was collected locally by all devices; namely, by vehicles A and B immediately, and by camera D and vehicle C with a delay. In some embodiments of the present invention, data is immediately uploaded to the cloud where it is kept private. As such, only the storage device is synced to the cloud but not yet shared to the end users, and data is only available to the owner of the device that recorded the data.

### Consent Messaging System

The motivation to share information may be built upon a community system or monetary feedback.

After a collision, each of device owner receives a share request notification.
1. Driver of vehicle A, which fled the collision, does not allow sharing his footage and requests to delete his data. The data is deleted from the dashcam of vehicle A, from the cloud, and from all logs. This is to allow trust in the system and maintain privacy
2. Driver of vehicle B receives a share notification, where he chooses to share his video data with his insurance provider 190.
3. Driver of vehicle C receives a share request, and gives consent, as he is part of the community, and is provided with emotional feedback using virtual tokens or by monetary feedback in some embodiments
4. The owner of traffic camera D receives a share notification, where he sets the consent to automatically agree as he set his camera to be public in the system

Evidence Collector 110 now has three pieces of evidence: from vehicles B and C, and from traffic camera D.
Evidence from vehicle B—Colliding vehicle A is not seen, but time, location and impact severity are given, where location and time accuracy are estimated by phone GPS, and where dashcam 120 was connected to the driver's phone for connectivity.
Evidence from vehicle C—Passing vehicle may see the event happen with both parties, but without the license plate number of vehicle A. Time and location are provided, and location and time accuracies are estimated by dashcam GPS.
   Evidence from camera D—both cars' license plates are seen prior to collision; the collision event is not seen but may be heard.

### Analysis and Adjustment

There are three evidence fragments. Each fragment alone does not suffice to perform a full claim adjustment, but together the fragments provide a full view of the event, in order to improve and accelerate the process. At this stage evidence collector 110 provides the full view of the event, in addition to direct access by the drivers whose data was shared, to analyzers 170 chosen by end users.
Data is shared with the insurance provider 190 of the driver of vehicle B, which asks for additional consent to share with the court of law, and requests an analysis from an identity analyzer and evidence collector 110. Driver of vehicle B gives consent via the system.
The evidence collected from vehicle C and camera D is shared with vehicle B, which then share data with the insurance provider 190 of vehicle B. Each share may or may not require additional consent from the original providers by the selected consent type.
Shared information may pass an anonymization process to hide filming party information, such as a dashboard of the vehicle with identity card, by selected share options or by default.
The selected analyzers may be human experts or AI. An expert analyzes the evidence where each new delayed evidence may re-trigger the process. The expert finds the license plate of vehicle A in evidence from camera D.
The insurance provider 190 of vehicle B contacts the insurance provider 190 of vehicle A, and may immediately provide the collision analysis output of the collision reconstruction service which, again, may use advanced measuring tools and a human expert or trained AI. A plurality of such service providers may be used.
The insurance providers 190 of vehicles A and B may arrive at a settlement, or share the evidence with a court of law, which uses an interface of the system to examine all raw data, and may require additional analysis to reach settlement.

A similar scenario commonly occurs while in parking mode and in other cases of hit-and-run, or cases where the involved party may not agree on what actually happened, as it is very common for traumatic events that each party has his own truth and believes in it while the real evidence shows a totally different story.

### Evidence Traceability

Depending on the embodiment of the present invention, each time an evidence request is generated, all of the parties that request, share or capture the evidence are notified, and full traceability is generated by each of the sub systems.

### Community Dashcam

One embodiment of the present invention is a community dashcam. When a driver purchases a dashcam 120, instead of having a single field of view, the dashcam is connected to a cloud, then connected to all other dashcam users with the supported connected dashcam forming a dashcam community. In case of an event 10 such as an emergency brake or a collision where a community driver was involved, all community drivers that are relevant get notifications requesting consent to share additional evidence. Each additional evidence is then sent to the involved driver.

### Dashcam Communication

The dashcam may communicate directly to a community server using LTE or other long range communication device, or be configured to use the driver's phone with a dedicated application, and use BLE, Wi-Fi or other short range communication modules. Event 10 is detected and its evidence is uploaded to cloud storage, together with any of the other community collected evidence.

### Detecting Relevant Evidence Drivers

To detect and ask consent from the relevant driver, a few methods may be used. The main target is to avoid requesting evidence that is not relevant, and to limit the number of consent requests from community drivers to a minimum. A first method is centralized and requires a community server to collect traces of each driver location. An advantage of this method is that it allows detecting relevant drivers also when they are offline and waking up remotely, if supported, any relevant device.

A second method is to send to any driver's dashcam 120 in the area a notification, and let the dashcam 120 decide if there was a relevant piece of evidence, with the downside of potential frequent wakeup but with the benefit of keeping all data local for privacy.

To determine if the evidence is relevant, a few factors are examined, including inter alia time that vehicle passed vs. evidence request time, and location and course of the community driver dashcam vs. location of evidence. If the distance in temporal and spatial domains is below a threshold, then the evidence is marked and a share consent is sent to the community driver. Additional evidence may also be collected at a different time at the same location and different angles at daylight, for example, with the objective of constructing a 3D model of the area for further analysis, or a simple manual inspection of road conditions at different times that provides additional insight about the event.

### Community Notification

To reach each driver of the community, the community server sends an SMS message to the associated phone number of each dashcam, which is provided on installation using a dedicated application or website.

A third method is to use a dashcam directly and use voice activation using the dashcam speaker and microphone or such other human interface. In addition, instead of using SM, a dedicated community application is installed in vehicles, which enables sharing details of a collision/event and allows an involved driver to agree and share his own evidence in the share request.

Prior to the evidence being shared, a community driver that has evidence is presented with the evidence shared in the consent process. He may also edit the start/end time of the evidence and, in case of visual evidence, may trim part of the video to avoid showing private information. No other editing of the evidence is permitted.

### Involved Driver Notification of New Evidence

Similar to the methods discussed in the community notification, upon issuing a new evidence request the driver involved is notified where an additional dedicated web page or application view provides access to evidence stored on the community server.

### Reward System

The driver involved in the event may reward back the community drivers by direct monetary or verbal recognition. In a fourth method, each of community driver shares his statistics, using actual names or nicknames, where each driver has his shared medals and ratings.

The community dashcam provider may also motivate sharing by providing monetary rewards for top contributors, or by another method.

### Detection of System Abuse

As evidence requests are auto-generated or manually generated by an SOS button for example, the requests come with evidence from an originating system. Once original evidence is uploaded, the community server applies human review or AI to detect system abuse, and to block propagation of a community evidence request.

In the foregoing specification, the invention has been described with reference to specific exemplary embodiments thereof. It will, however, be evident that various modifications and changes may be made to the specific exemplary embodiments without departing from the broader spirit and scope of the invention. Accordingly, the specification and drawings are to be regarded in an illustrative rather than a restrictive sense.

What is claimed is:

1. A system for scene reconstruction from data captured by a network of sensors, comprising:
a plurality of sensors capturing evidence of a scene in which an event occurred;
a processor collecting the evidence captured by said sensors and adding temporal and spatial data to each evidence, in response to the event having occurred;
a consent messager transmitting messages in the form of data requests and evidence to owners of said sensors, and receiving messages in the form of consents from the owners;
a network connecting said sensors, said processor and said consent messager;
a plurality of analyzers; and
an interface enabling analysis by said analyzers of evidence for which said consent messager received a consent, to reconstruct the scene when and where the event took place.

2. The system of claim 1, wherein said sensors comprise traffic cameras, smartphone cameras and vehicle dashcams.

3. The system of claim 1, wherein consents received by said consent messager comprise auto-consent, one-time consent, delayed consent and revocable consent.

4. The system of claim 1, wherein said network comprises a vehicle-to-vehicle network or an event-to-event network.

5. The system of claim 1, wherein said analyzers comprise automated analyzers or human expert analyzers.

6. The system of claim 1, wherein said processor provides measurement accuracies for the temporal and spatial data added to evidence.

7. The system of claim 1, wherein the event is a collision between moving vehicles.

8. A method for reconstructing a scene from data captured by a network of sensors, comprising:
in response to occurrence of an event, collecting evidence captured by a plurality of sensors;
adding temporal and spatial data to each evidence;
transmitting messages in the form of data requests and evidence to owners of the sensors;
receiving messages in response to said transmitting in the form of consents from the owners; and
analyzing evidence for which a consent was received to reconstruct the scene when and where the event took place.

9. The method of claim 8, wherein the sensors comprise traffic cameras, smartphone cameras and vehicle dashcams.

10. The method of claim 8, wherein consents received by said consent messager comprise auto-consent, one-time consent, delayed consent and revocable consent.

11. The method of claim 8, wherein evidence and messages are transmitted via a vehicle-to-vehicle network or via an event-to-event network.

12. The method of claim 8, further comprising providing measurement accuracies for the temporal and spatial data added to evidence.

13. The method of claim 8, wherein the event is a collision between moving vehicles.
